(19) United States
(12) Patent Application Publication
(10) Pub. No.: US 2020/0364961 A1
(43) Pub. Date: Nov. 19, 2020

(54) Vehicle Transmitter Training

(71) Applicant: The Chamberlain Group, Inc., Oak Brook, IL (US)

(72) Inventors: Bradley Charles Atwell, North Aurora, IL (US); Garth Wesley Hopkins, Lisle, IL (US); Oddy Khamharn, Lombard, IL (US); Edward James Lukas, Batavia, IL (US); Mark Edward Miller, Woodridge, IL (US); Jay Edward Peterson, Westmont, IL (US)

(21) Appl. No.: 16/871,844

(22) Filed: May 11, 2020

Related U.S. Application Data
(60) Provisional application No. 62/848,764, filed on May 16, 2019.

(51) Int. Cl. G07C 9/10; G07C 9/00

(52) U.S. Cl. CPC G07C 9/10; G07C 9/00309

(57) ABSTRACT

In an embodiment, an in-vehicle apparatus includes a transmitter operable to transmit radio frequency control signals and communication circuitry configured to communicate with a remote computer via a network. The communication circuitry is configured to receive information from the remote computer via the network, the information pertaining to one or more controllable devices of a user account. The apparatus includes a processor configured to: communicate, via the communication circuitry, a transmitter identifier representative of a transmitter code of the transmitter with the remote computer; effect the movable barrier operator to change a state of a movable barrier by causing the transmitter to transmit a first radio frequency control signal to the movable barrier operator system; and effect the movable barrier operator to learn the transmitter by causing the transmitter to transmit a second radio frequency control signal to the movable barrier operator system.

### CROSS-REFERENCE TO RELATED APPLICATION

This application claims the benefit of U.S. Provisional application No. 62/848,764, filed May 16, 2019, which is incorporated by reference in its entirety herein.

### TECHNICAL FIELD

This disclosure relates generally to transmitters for controlling appliances and, in particular, to an in-vehicle transmitter operably coupled to a human-machine interface for controlling the in-vehicle transmitter.

### BACKGROUND

An increasing number of vehicles sold today include universal transmitters built into the vehicle that allow a driver or vehicle passenger to control devices such as a garage door opener regardless of the manufacturer of the opener. Users control such transmitters via a human machine interface (HMI) or a user interface integral or unitary to the vehicle. Universal transmitters are configured to control a particular garage door opener or other external device based on some training or set up operations performed by the user. Users engage the user interface to perform the training or configuration of the universal transmitter. Many times, the user refers to additional resources including instructional videos, online tutorials, and paper instructions such as the vehicle's owner manual to facilitate the set-up process.

Other automotive trends include the increasing use of touch screens as the primary interface for the vehicle. These touch screen interface units, typically located in the dashboard of the vehicle and called “center stack” units, are used to control various features and functions of the vehicle, for example, a built-in universal transmitter, navigation, infotainment, telematics, audio devices, climate control, and the like. The center stack communicates with an in-vehicle computing device to facilitate these features and functions. With the number of features available on the center stack, setting up the different features presents an increasing effort on the part of the vehicle user, especially upon first acquiring the vehicle.

### BRIEF DESCRIPTION OF THE DRAWINGS

The in-vehicle transmitter training is set forth in the following detailed description, particularly in conjunction with the drawings, wherein:

FIGS. 1A and 1B comprise a flow diagram showing example communications among several elements of a vehicle, network, and a movable barrier operator system;

FIG. 2 comprises a series of example screens as may be displayed on a center stack display unit; and

FIG. 3 comprises a series of example screens as may be displayed on a center stack display unit;

FIG. 4 is an example block diagram of the communication between the vehicle, network, and movable barrier operator system;

FIG. 5 is an example block diagram of the vehicle of FIG. 4;

FIG. 6 is an example block diagram of the movable barrier operator system of FIG. 4; and

FIG. 7 is an example block diagram of a remote computer associated with the network of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an in-vehicle or center stack control system can be used to facilitate training of a vehicle mounted universal transmitter in a way that allows a user to forego use of supplemental/additional resources such as paper-based or electronic-based tutorials, videos or instructions. In certain approaches, an internet connection is not needed to allow the user to set up the transmitter to control a movable barrier operator or other controllable device, such as a light or door lock.

In one aspect of the present disclosure, an in-vehicle apparatus is provided that includes a transmitter operable to transmit radio frequency control signals, and communication circuitry configured to communicate with a remote computer via a network. The communication circuitry is configured to receive information from the remote computer via the network, the information pertaining to one or more controllable devices including a movable barrier operator system associated with a user account. The controllable devices may include, for example, a light, a lock, and/or a security system of a home. The in-vehicle apparatus includes a user interface configured to receive a user input requesting control of the movable barrier operator system and a processor operably coupled to the transmitter, communication circuitry, and user interface.

The processor is configured to communicate with the remote computer, via the communication circuitry, a transmitter identifier representative of a transmitter code of the transmitter. The communication may involve the communication circuitry communicating the transmitter identifier to the remote computer. For example, the transmitter identifier may include a hash of a fixed code of the transmitter and the processor causes the communication circuitry to communicate the hash of the fixed code to the remote computer. As another example, the communication may involve the communication circuitry receiving the transmitter identifier from the remote computer. For example, the transmitter identifier may include encoded information that is decoded by the processor and used by the processor to set the transmitter code, such as a one-time-use passcode.

The processor is configured to effect the movable barrier operator to change a state of a movable barrier (e.g., a garage door) by causing the transmitter to transmit a first radio frequency control signal to the movable barrier operator system, wherein the first radio frequency control signal includes the transmitter code. The processor is further configured to effect the movable barrier operator to learn the transmitter by causing the transmitter to transmit a second radio frequency control signal to the movable barrier operator system. In this manner, the in-vehicle apparatus may cause the movable barrier operator to change the state of the movable barrier via the first radio frequency control signal and may cause the movable barrier operator to learn the transmitter via the second radio frequency control signal.

In one embodiment, the processor is configured to cause the transmitter to transmit the first radio frequency control signal at a first frequency and transmit the second radio frequency control signal at a second frequency different than the first frequency. For example, the first frequency may be in the range of approximately 300 MHz to approximately 400 MHz and the second frequency may be in the range of approximately 900 MHz to approximately 1 GHz. The different frequencies of the first and second radio frequency control signals may facilitate the movable barrier operator identifying the first radio frequency control signal including the transmitter code and changing the state of the movable barrier.

In another aspect of the present disclosure, a movable barrier operator system is provided that includes a motor and communication circuitry configured to receive an add transmitter request from a remote computer via a network, the add transmitter request including a transmitter identifier. The communication circuitry is configured to receive a first radio frequency control signal and a second radio frequency control signal from an unknown in-vehicle transmitter, wherein the first radio frequency control signal includes a transmitter code. The movable barrier operator system includes processor circuitry configured to cause the motor to change a state of the movable barrier upon the transmitter code of the first radio frequency control signal corresponding to the transmitter identifier. The processor circuitry is further configured to learn the unknown in-vehicle transmitter in response to the communication circuitry receiving the second radio frequency control signal.

For example, the transmitter code may include a fixed code of the unknown in-vehicle transmitter and the transmitter identifier may include a hash of the fixed code. The processor may perform a hash function on the fixed code hash to determine the fixed code. The processor circuitry may determine that the transmitter code corresponds to the transmitter identifier if the fixed code determined using the hash function matches the fixed code of the first radio frequency control signal. In another approach, the processor circuitry may determine that the transmitter code corresponds to the transmitter identifier if the similarity of the transmitter code and the transmitter identifier is greater than a threshold.

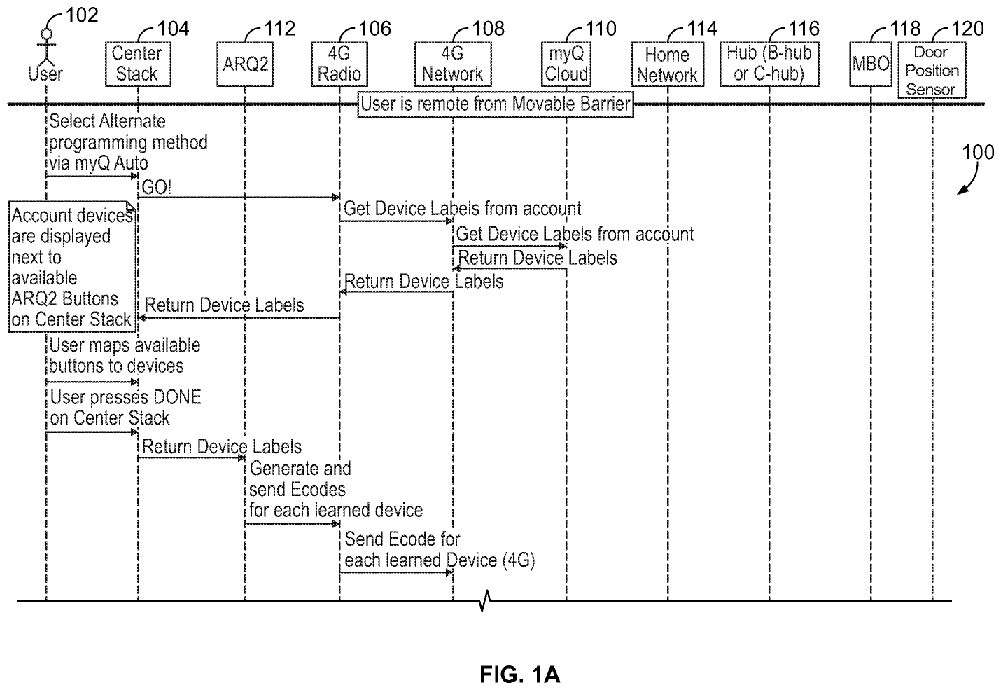

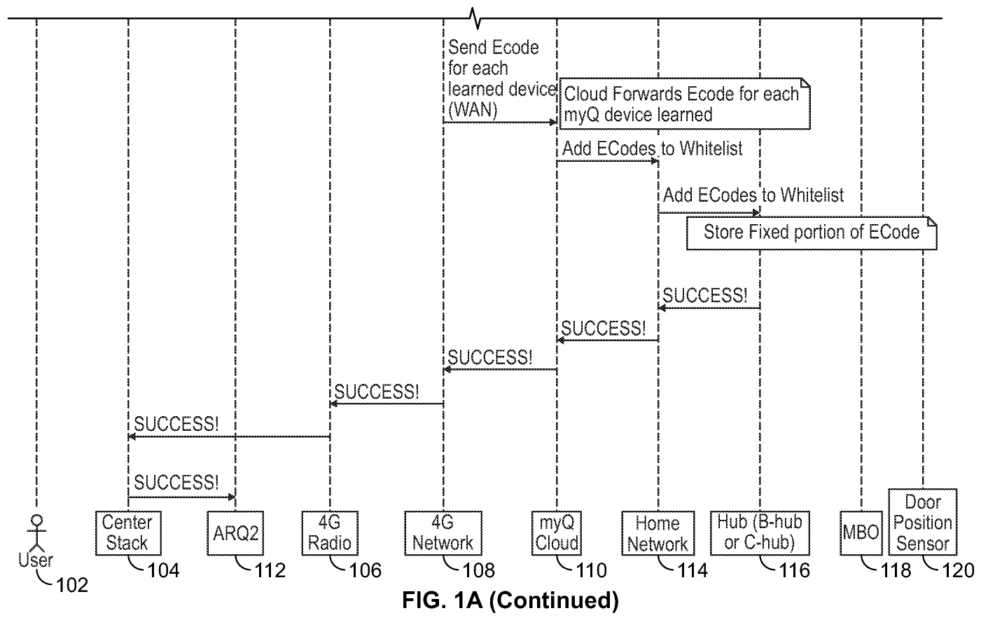

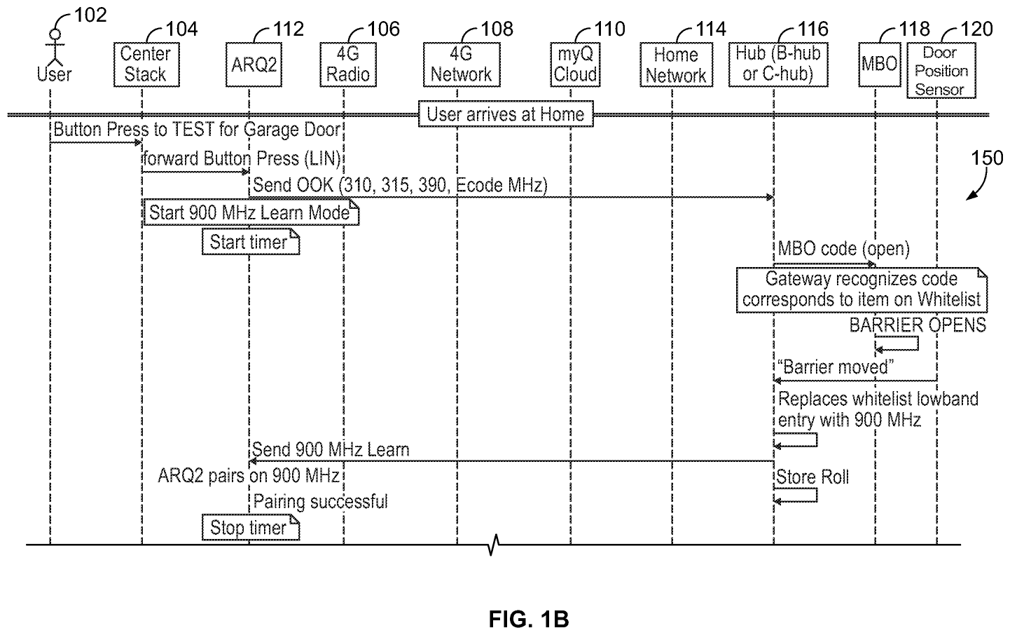

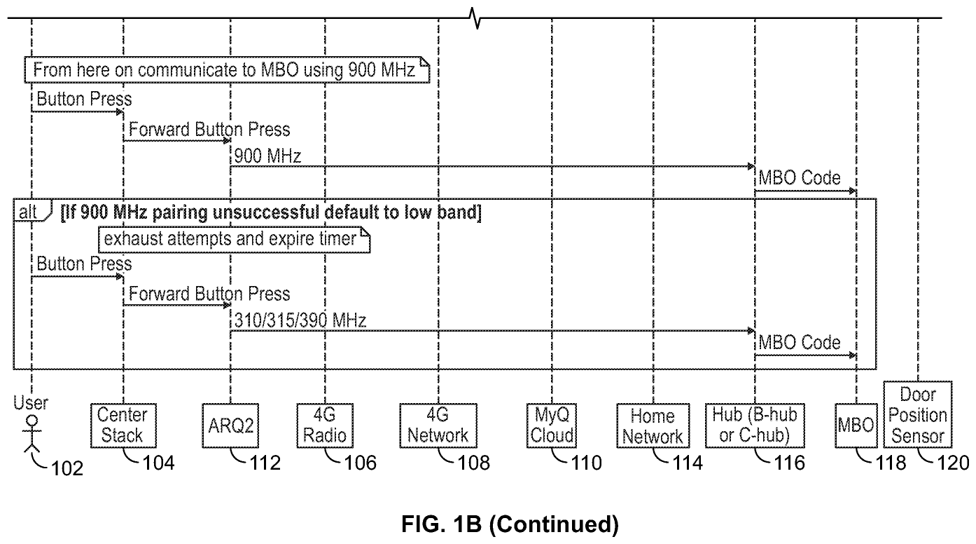

Referring now to the drawings, and in particular to FIG. 1 constituted by FIGS. 1A and 1B, an illustrative process 100 that is compatible with many of these teachings will now be presented. A user 102 selects a programming method via a software-based application (or “app”) in a user interface such as the center stack 104. The center stack 104 communicates with the vehicle's computing system to activate or open a network connection between the vehicle and a wide-area network such as the Internet. In the example of FIG. 1A, this connection includes a 4G radio 106 disposed in the vehicle that communicates with a 4G network 108, thereby providing access to the Internet. In other examples, other technologies and/or wide area networks (e.g., Long Term Evolution (LTE), 5G/NR, etc.) available to allow an Internet connection for the vehicle may be used. As illustrated, the 4G radio 106 in the vehicle communicates with a 4G network 108 to connect to a remote computer 110, such as a cloud based computing system or middleware, executing a server or service associated with the software client app in the vehicle, here labeled the “myQ cloud.” If the user is using the software client app for the first time, the user may login to the cloud based account via the client app on the center stack 104. This login will then request labels (e.g., human-readable names or identifiers) of devices associated with the user's account that are stored in the cloud-based account. In response to this request, the cloud-based account will return the device labels through the 4G network 108 to the 4G radio 106 in the vehicle, which then will present or otherwise display the returned device labels on the center stack 104. In this example, the user may then map the device labels to particular virtual or physical buttons or other user interface features in the vehicle or in the center stack 104.

In certain examples, software available on the center stack 104 or in a transmitter, such as universal transmitter 112 shown as “ARQ2,” mounted in the car may generate codes for each or a set of the devices having labels mapped thereto. The codes are generated independently of the labels downloaded from the cloud based system 110. The codes can be used to facilitate pairing of the transmitter 112 and the mapped devices upon arrival of the vehicle at the home. As illustrated in FIG. 1A, the vehicle based universal transmitter 112 labeled ARQ2 generates and sends these codes called Ecodes to the cloud-based system (labeled myQ Cloud) via the vehicle's 4G radio 106 and the Internet connected 4G network 108. The cloud based system 110 in turn delivers the Ecodes via the Internet to the home based or local network 114 (although the network may be instantiated at any physical location, not necessarily a home), which is operatively connected to a hub device 116 (or optionally the end device itself such as the movable barrier operator, light, lock, and the like). The hub device 116 (or end device) stores the code for later pairing with the transmitter device 112. Optionally, the hub device 116 may send a success acknowledgement through the home network 114, cloud-based system 110, and 4G internet connection 108 to the vehicle-based radio for receipt by the vehicle center stack software app and the vehicle based universal transmitter 112, which may acknowledge this receipt in the user display of the center stack 104.

Turning to FIG. 1B, an example method 150 for completing the learning of the universal transmitter 112 to the home-based device is shown. When the user 102 arrives at home with the vehicle, the user may select one of the previously mapped buttons or user interface elements such as a touch element of the center stack 104 to attempt to operate the associated home-based device. In the illustrated example, user presses the button for operating the movable barrier operator (MBO) 118 on the center stack 104. The center stack 104 receives the button press, and signals to the universal transmitter 112 to send a code signal to the receiving device in the home, here illustrated as the hub device 116 (or, as discussed with reference to FIG. 1A, optionally the end device itself such as the movable barrier operator 118, light, lock, and the like). In this example, the signal sent by the universal transmitter 112 is in the range of a 300 MHz-400 MHz frequency signal as is customary for certain movable barrier operators, such as garage door openers. The hub device 116 compares this signal (sent from the universal transmitter 112 and received by hub device 116) to the previously received Ecode signal to determine whether the signal received from the universal transmitter 112 corresponds to the previously received Ecode (see FIG. 1A—operations of: Generate and send Ecodes for each learned device; Send Ecode for each learned device (4G); Cloud forwards Ecode for each myQ device learned; and Add Ecodes to Whitelist). Based on this determination or comparison of the previously-received (indirectly via network) Ecode and the newly-received (transmitted 300 MHz-400 MHz) Ecode, the hub device 116 operates the movable barrier operator 118 if the comparison result is true (i.e., Ecodes substantially match or match in a relevant portion thereof) and sends an acknowledgement signal back to the universal transmitter 112. A door position sensor 120 may be used to detect when the position of the movable barrier changes. In the illustrated example, the system uses this exchange of signals to configure the universal transmitter 112 to operate in future activations in a 900 MHz-1 GHz transmission mode. Therefore, additional actuations by the user of the garage button in the center stack 104 cause the universal transmitter 112 to send associated signaling to the hub device 116 or movable barrier operator 118 using 900 MHz-1 GHz signaling. So configured, the system is able to pair the universal transmitter 112 with the home based device with minimal interaction by the user. Moreover, from the user's perspective, logging into the cloud based system on the vehicle center stack 104 before even reaching home appears to have configured the transmitter 112 for use with the home based devices. If the 900 MHZ-1 GHz signaling was unsuccessful in permitting the movable barrier operator 118 to learn the universal transmitter 112, the method 150 may include defaulting back to signals in the 300 MHz-400 MHz band to complete learning as shown in FIG. 1B.

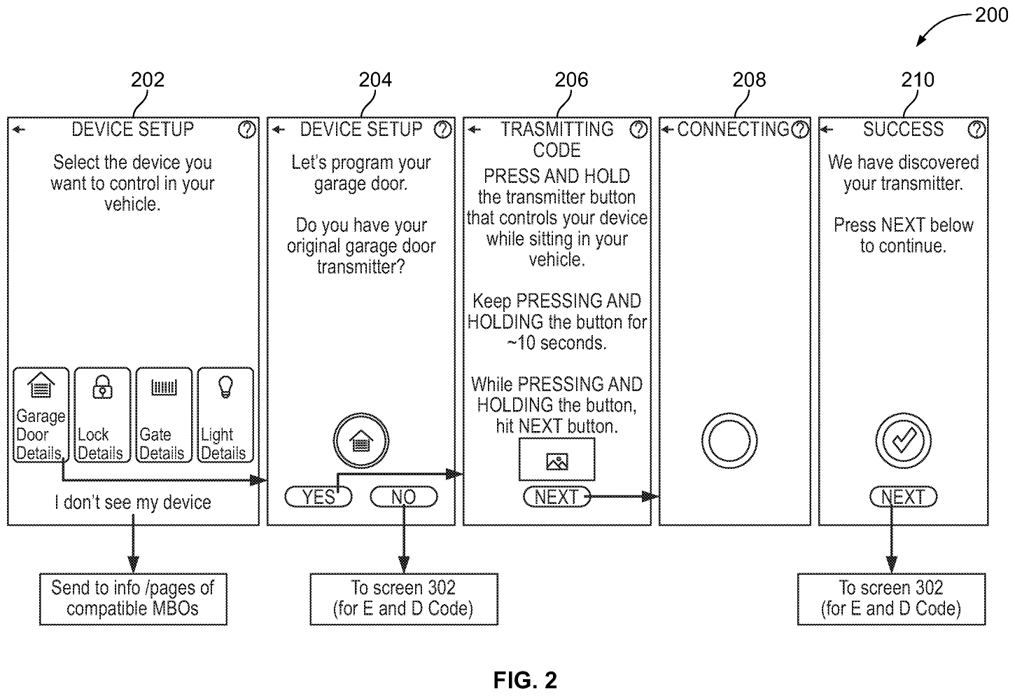

An example series of graphical user interface screens displayed to the user in setting up the universal transmitter 112 according to an illustrative process 200 is illustrated in FIG. 2. At screen 202 presentation of the list of devices (e.g., device labels) downloaded from the user's cloud-based account or as may be available for use with the universal transmitter 112 is shown. In this example, the user selects the movable barrier operator 118 for device setup. In response to this selection, screen 204 is displayed, which asks whether the user has the original movable barrier operator transmitter available to assist in training the universal transmitter 112 mounted within the vehicle. If yes, the center stack 104 will proceed through screens 206, 208, and 210 as illustrated in FIG. 2. In screen 206 the user is instructed to press and hold the button of the original movable barrier operator transmitter to allow for training the universal transmitter 112 mounted in the vehicle. The center stack 104 instruction guides the user through this process by including specific instructions in screen 206 for the user to follow. After pressing “next” on screen 206, the center stack 104 will display screen 208 to inform the user with respect to the connection process, eventually transitioning to screen 210 to indicate success in the universal transmitter's 112 receiving the signal from the original transmitter.

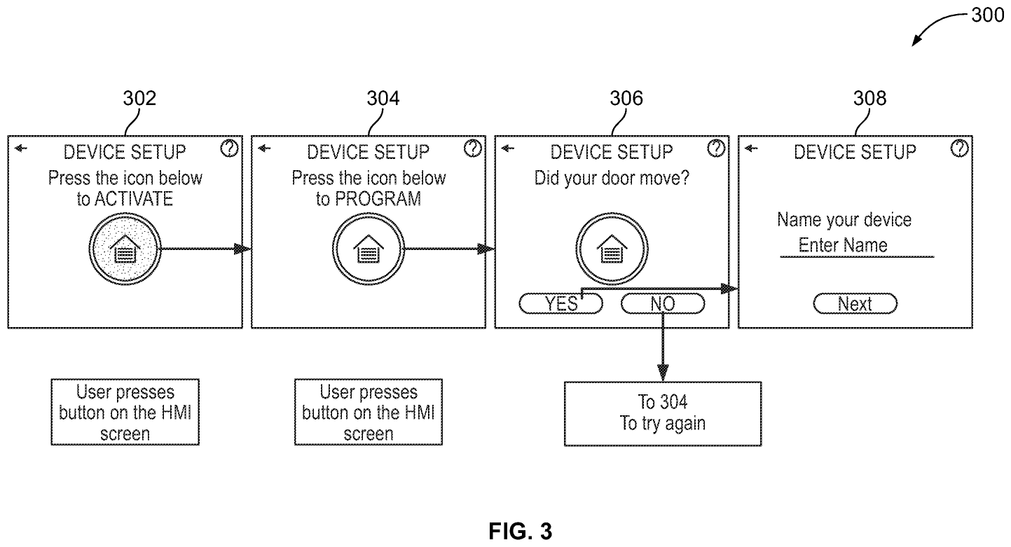

Turning to FIG. 3, an additional series of example graphical user interface screens displayed by the center stack 104 is illustrated. This sequence of screens will be displayed in connection with operating the movable barrier operator 118 according to an illustrative process 300, for example, when the user arrives home with a new vehicle having a universal transmitter 112 as described above with respect to FIG. 1. In this sequence, a garage icon is provided in screen 302 for the user to select (e.g., via a tap, press, long press, multi-point gesture, etc.) to trigger the universal transmitter 112 to transmit a signal to operate the movable barrier operator 118. In some situations, a second signal may be sent from the universal transmitter 112 to the universal movable barrier operator 118 to facilitate pairing of the transmitter 112 and the opener 118. In that situation, screen 304 provides another icon prompt for the user to select in order to trigger the universal transmitter 112 to send the additional signal. If this is the first time that the universal transmitter 112 has been used, screen 306 may be provided to allow the user to confirm whether the movable barrier (e.g., garage door) has been moved. If the movement was successful, the user may be prompted in screen 308 to provide an additional name or label for the movable barrier operator 118, especially if this is a new movable barrier operator as opposed to one that was associated with the label downloaded in accord with the process 100 described above with reference to FIG. 1. If the user instead indicates on screen 306 that the movable barrier did not move, an additional set up process may be initiated in response to the user feedback.

A different set of screens may be presented if interaction with the end device facilitates pairing the end device with the universal transmitter 112. For example, a screen can be presented to instruct the user to find and press a learn button or program button on the end device.

An additional series of screens may be used to step the user through the pairing process for certain types of end devices. For example, a series of garage icons is presented to prompt the user to press the respective icons, which in turn triggers the universal transmitter 112 to send various signaling to the end device as may be employed to train the universal transmitter 112 to operate with that end device. For example, a screen may prompt the user to press the garage icon, and a second screen prompts the user to press a second garage icon to facilitate programming between the universal transmitter 112 and the end device. A third screen prompts the user to press the garage icon again to test whether the pairing was successful. A fourth screen requests confirmation from the user as to whether the movable barrier moved as a result of this training process. If successful, a screen can be provided to allow the user to customize or provide a new name or label for the newly learned movable barrier operator 118.

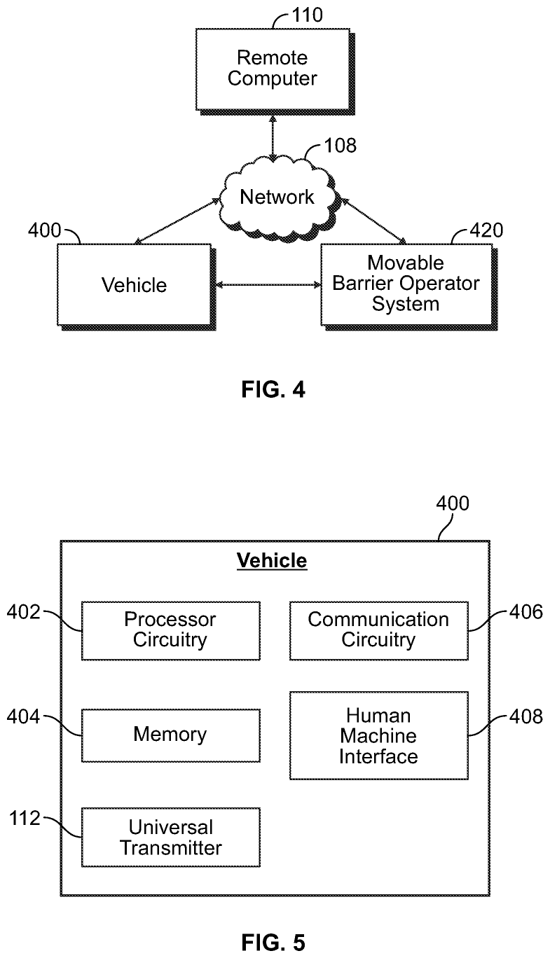

With reference now to FIG. 4, a vehicle 400 may be a “connected car” in communication with the remote computer 110 via the network 108, such as a 4G network or other long-range or wide-area wireless networks (e.g., LoRaWan, vehicle to anything (V2X), or WiMax networks and the internet). The remote computer 110 may include a server computer associated with a movable barrier operator system 420, for example, maintained and/or operated by a manufacturer of the movable barrier operator system 420. As discussed with regard to FIG. 1A, the vehicle 400 may communicate with remote computer 110 to receive a list of the controllable devices associated with a user account. The user may program the vehicle 400 to control one or more of the controllable devices associated with the user account via the universal transmitter 112. The vehicle 400 may communicate a transmitter identifier to the remote computer 110 for the remote computer 110 to send to the movable barrier operator system 420 for learning the universal transmitter 112 to the movable barrier operator system 420. The transmitter identifier code may include a code, token, or credential as some examples. The movable barrier operator system 420 may determine whether signals received include the transmitter identifier. If a signal is determined to include the transmitter identifier, the movable barrier operator system 420 may begin to learn the universal transmitter 112 to the movable barrier operator system 420. As one example, the transmitter identifier includes a fixed portion of code of the universal transmitter 112 that identifies the universal transmitter 112. The fixed portion of the code may be hashed or encrypted by the vehicle 400 or remote computer 110 before transmission across the network 108. The movable barrier operator system 420 may be configured to compare the hashed or encrypted code with the code received from the vehicle 400 to determine whether the codes correspond to one another.

The remote computer 110 may be in communication with the movable barrier operator system 420 via the network 108, e.g., the internet and a local Wi-Fi network. The remote computer 110 may be configured to control and/or monitor the status of the movable barrier operator system 420. For example, the remote computer 110 may communicate control signals to the movable barrier operator system 420 to change the state (e.g., open/close) of an associated movable barrier, e.g., a garage door.

The movable barrier operator system 420 may be configured to receive signals from the universal transmitter 112 of the vehicle 400, for example, radio frequency (RF) signals. The movable barrier operator system 420 may be configured to monitor for a signal that includes the transmitter identifier received from the vehicle 400 via the remote computer 110. To determine whether a signal includes the transmitter identifier, the movable barrier operator system 420 may compare a RF signal received to the transmitter identifier received from the remote computer 110. If a signal sufficiently corresponds to the transmitter identifier, the movable barrier operator system 420 may enter a learn mode or communicate with the universal transmitter 112 of the vehicle to learn the universal transmitter 112 to the movable barrier operator system 420.

Regarding FIG. 5, the vehicle 400 may include processor circuitry 402 and memory 404. The memory 404 may store programs and instructions for execution by the processor circuitry 402 to carry out the functionality of the vehicle 400 computer system. This may include, as examples, instantiating the vehicle navigation system and/or infotainment system. The processor circuitry 402 may communicate with remote devices via the communication circuitry 406. As an example, the communication circuitry 406 may facilitate communication between the processor circuitry 402 and devices on network 108, e.g., the remote computer 110. The communication circuitry 406 may be configured to communicate over one or more wireless communication protocols including, for example, wireless fidelity (Wi-Fi), cellular such as 3G, 4G, 4G LTE, 5G, radio frequency (RF), infrared (IR), Bluetooth (BT), Bluetooth Low Energy (BLE), Zigbee and near field communication (NFC). The processor circuitry 402 may also be configured to control the universal transmitter 112. The universal transmitter 112 may be configured to communicate via RF signals, e.g., the RF signals may be in the 300 MHz-400 MHz range, such as 310 MHz, 315 MHz, 390 MHz, and/or in the 900 MHz-1 GHz range, such as 900 MHz. The transmitter 112 may be configured as a transceiver to both send and receive RF signals.

The vehicle 400 may include a user interface such as a human machine interface 408. The human machine interface 408 may include a touchscreen display, such as a display of the center stack 104 or infotainment system of the vehicle 400. Additionally or alternatively, the human machine interface 408 may include an augmented reality display or heads-up display, button(s), a microphone, and/or speaker(s) 125 as examples. Upon receiving device labels from the cloud-based account, one or more aspects of the human machine interface 408 may be used to control the end devices of the cloud-based account. For example, the user may associate a physical or virtual button with a movable barrier operator 118 such that when the button is selected, a control signal is output for that movable barrier operator 118. As another example, the user may speak a command into a microphone of the vehicle 400, e.g., “Open left garage door,” to cause the vehicle 400 to output a control signal for that movable barrier operator 118.

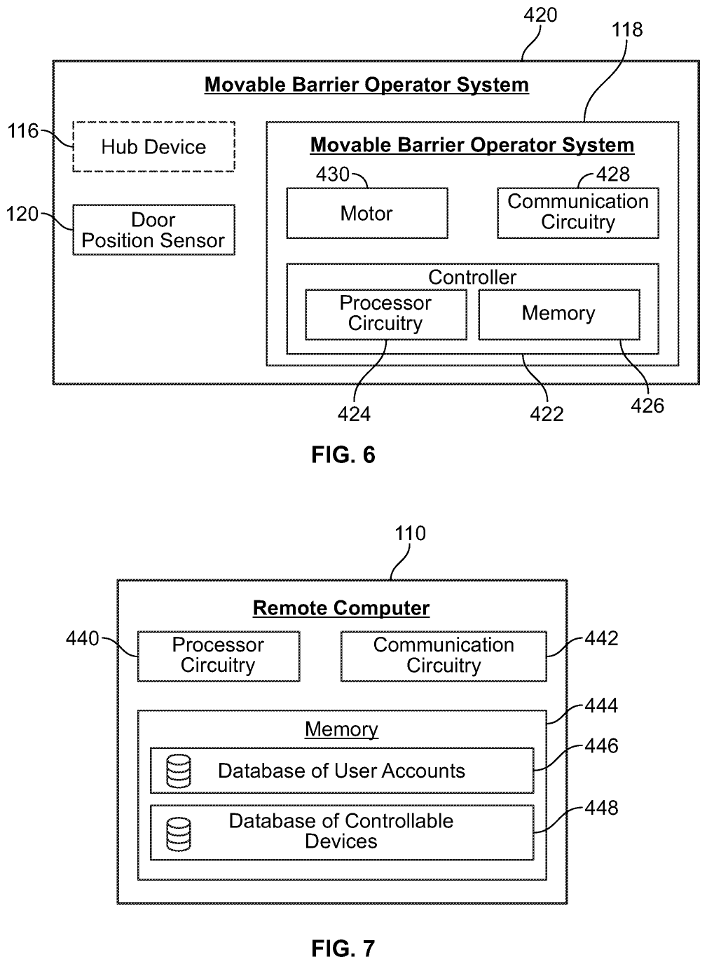

Regarding FIG. 6, the movable barrier operator system 420 may include the movable barrier operator 118, the door position sensor 120, and a hub device 116. The movable barrier operator 118 includes a controller 422 that includes processor circuitry 424 and memory 426. The memory 426 is non-transitory computer readable media that may store programs and information. The memory 426 may store learned transmitters in a whitelist of transmitters. The movable barrier operator 118 may be actuated in response to receiving a control signal from a learned transmitter that has been stored in the whitelist. The whitelist may include a fixed code and a changing (e.g., rolling) code of learned transmitters. The memory 426 may store the transmitter identifier for comparison to signals received via the communication circuitry 428. The processor circuitry 424 may be configured to process signals received via the communication circuitry 428 to determine whether to change the state of the movable barrier or to learn a transmitter into the whitelist of transmitters in memory 426.

The controller 422 may be in communication with the communication circuitry 428. The communication circuitry 428 enables the movable barrier operator 118 to communicate with devices external to the movable barrier operator 118 directly and/or over network 402. The controller 422 may communicate with the remote computer 110 and the movable barrier operator system 420 via communication circuitry 428. The communication circuitry 428 may enable the movable barrier operator 118 to communicate over wireless protocols, for example, wireless fidelity (Wi-Fi), cellular, radio frequency (RF), infrared (IR), Bluetooth (BT), Bluetooth Low Energy (BLE), Zigbee and near field communication (NFC).

The controller 422 is configured to operate the motor 430. The controller 422 may operate the motor 430 in response to a state change request received via the communication circuitry 428 to operate the motor 430. The motor 430 may be coupled to the movable barrier to change the state of the movable barrier, i.e., move the movable barrier to an open, closed, or intermediate position. The controller 422 may also be in communication with a door position sensor 120. The door position sensor 120 may be used to monitor the state of the movable barrier, e.g., open, closed, or in between states. The door position sensor 120 may be as an example a tilt sensor. As another example, the door position sensor 120 may detect door position by monitoring movement of one or more components of a transmission of the movable barrier operator 118 such as via an optical encoder.

The movable barrier operator system 420 may optionally include a hub device 116. The hub device 116 may be used to facilitate communication between the movable barrier operator 118 and the network 108. The hub device 116 may be configured to communicate with the remote computer 110 via the network 108. The hub device 116 may send control commands to the movable barrier operator 118 to change the state of the movable barrier. The hub device 116 may be configured to communicate with the movable barrier operator 118 via a wired or wireless connection, e.g., via an RF signal. The hub device 116 may be configured to receive RF signals from the transmitter 112 of the vehicle 400. The hub device 116 may learn the transmitter 112 as described in relation to the movable barrier operator 118.

With reference to FIG. 7, the remote computer 110 includes processor circuitry 440 in operative communication with memory 444 and communication circuitry 442. The processor circuitry 440 may be configured to receive the transmitter identifier from the vehicle 400 and store the transmitter identifier in memory 444. The processor circuitry 440 may be configured to encrypt or hash all or a portion of the transmitter identifier. The processor circuitry 440 may send the transmitter identifier to the movable barrier operator system 420. The communication circuitry 442 enables the remote computer 110 to communicate with other devices over the network 108, for example the internet. Specifically, the communication circuitry 442 enables the remote computer 110 to send information to and receive information from the vehicle 400 and movable barrier operator system 420. The remote computer 110 may be associated with the movable barrier operator 118 and/or the hub device 116. As one example, the remote computer 110 is a server computer associated with a client application that is configured to control movable barrier operator 118. The client application may be instantiated in a user device such as the center stack 104, a smartphone, a wearable such as a smartwatch, tablet computer, and/or personal computer.

The memory 444 may include a database of user accounts 446. The user account may be an account that associates a user with one or more movable barrier operators and/or other controllable devices. The user account may be used to remotely control the movable barrier operator, for example, via a smartphone application. The memory 444 may also include a database of controllable devices 448 associated with the user accounts. The database of controllable devices 448 may be a list of devices such as movable barrier operators a user associates with their user account upon installation or for remote control. Upon a request from the vehicle 400 for controllable devices associated with a certain user account, the remote computer 110 may send the controllable devices in the database of movable barrier operator systems 448. The user may then select, within their vehicle, which of the controllable devices they wish to control with their vehicle.

Those skilled in the art will appreciate that the above-described processes may be implemented using any of a wide variety of available and/or readily configured platforms, including partially or wholly programmable platforms as are known in the art or dedicated purpose platforms as may be desired for some applications. Those skilled in the art will recognize and appreciate that such processor devices can comprise a fixed-purpose hard-wired platform or can comprise a partially or wholly programmable platform. All of these architectural options are well known and understood in the art and require no further description here.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

What is claimed is:

1. An in-vehicle apparatus comprising:
a transmitter operable to transmit radio frequency control signals;
communication circuitry configured to communicate with a remote computer via a network;
the communication circuitry configured to receive information from the remote computer via the network, the information pertaining to one or more controllable devices including a movable barrier operator system associated with a user account;
a user interface configured to receive a user input requesting control of the movable barrier operator system;
a processor operably coupled to the transmitter, communication circuitry, and user interface, the processor configured to:
communicate with the remote computer, via the communication circuitry, a transmitter identifier representative of a transmitter code of the transmitter;
effect the movable barrier operator to change a state of a movable barrier by causing the transmitter to transmit a first radio frequency control signal to the movable barrier operator system, the first radio frequency control signal including the transmitter code; and
effect the movable barrier operator to learn the transmitter by causing the transmitter to transmit a second radio frequency control signal to the movable barrier operator system.

2. The in-vehicle apparatus of claim 1 wherein the processor is configured to cause the transmitter to transmit the first radio frequency control signal at a first frequency and transmit the second radio frequency control signal at a second frequency different than the first frequency.

3. The in-vehicle apparatus of claim 2 wherein the first frequency is in the range of approximately 300 MHz to approximately 400 MHz; and
wherein the second frequency is in the range of approximately 900 MHz to approximately 1 GHz.

4. The in-vehicle apparatus of claim 1 wherein the communication circuitry is configured to communicate a credential of the user account to the remote computer via the network.

5. The in-vehicle apparatus of claim 4 wherein the user interface is configured to receive the credential from a user.

6. The in-vehicle apparatus of claim 1 wherein the transmitter code includes a fixed code of the transmitter; and
wherein the processor is configured to cause the transmitter to transmit the second frequency control signal including the fixed code and a changing code of the transmitter.

7. The in-vehicle apparatus of claim 1 wherein the transmitter identifier includes a hash of the transmitter code; and
wherein the processor is configured to cause the communication circuitry to communicate the hash of the transmitter code with the remote computer.

8. The in-vehicle apparatus of claim 1 wherein the communication circuitry is configured to receive the transmitter identifier from the remote computer; and
wherein the processor is configured to determine the transmitter code based at least in part on the transmitter identifier.

9. The in-vehicle apparatus of claim 1 wherein the processor is configured to cause the transmitter to transmit the second radio frequency control signal including the transmitter code.

10. The in-vehicle apparatus of claim 1 wherein the user interface is configured to receive first and second user inputs; and
wherein the processor is configured to cause the transmitter to transmit the first radio frequency control signal in response to the user interface receiving the first user input; and
wherein the processor is configured to effect the movable barrier operator to learn the transmitter by causing the transmitter to transmit the second radio frequency control signal to the movable barrier operator in response to the user interface receiving the second user input.

11. The in-vehicle apparatus of claim 1 wherein the user interface includes a display; and
wherein the user interface facilitates showing on the display a representation of the movable barrier operator system based at least in part on the information received from the remote computer.

12. A movable barrier operator system comprising:
a motor configured to be connected to a movable barrier;
communication circuitry configured to receive an add transmitter request from a remote computer via a network, the add transmitter request including a transmitter identifier;
a memory configured to store the transmitter identifier;
the communication circuitry configured to receive a first radio frequency control signal and a second radio frequency control signal from an unknown in-vehicle transmitter, the first radio frequency control signal including a transmitter code; and
processor circuitry operably coupled to the motor, memory, and the communication circuitry, the processor circuitry configured to:
cause the motor to change a state of the movable barrier upon a determination that the transmitter code of the first radio frequency control signal corresponds to the transmitter identifier; and
learn the unknown in-vehicle transmitter in response to the communication circuitry receiving the second radio frequency control signal.

13. The movable barrier operator system of claim 12 wherein the communication circuitry is configured to receive the first radio frequency control signal at a first frequency and the second radio frequency control signal at a second frequency different than the first frequency.

14. The movable barrier operator system of claim 13 wherein the first frequency is in the range of approximately 300 MHz to approximately 400 MHz; and
wherein the second frequency is in the range of approximately 900 MHz to approximately 1 GHz.

15. The movable barrier operator system of claim 12 wherein the transmitter code includes a fixed code of the transmitter; and
wherein the processor is configured to learn the unknown in-vehicle transmitter including storing the fixed code in the memory.

16. The movable barrier operator system of claim 15 wherein the second radio frequency control signal includes a changing code; and
wherein the processor is configured to learn the unknown in-vehicle transmitter including storing the changing code in the memory.

17. The movable barrier operator system of claim 12 wherein the transmitter identifier includes a hash of the transmitter code; and
wherein the processor is configured to perform a hash function on the transmitter code to determine whether the transmitter code of the first radio frequency control signal corresponds to the transmitter identifier.

18. The movable barrier operator system of claim 12 wherein the processor is configured to learn the unknown in-vehicle transmitter in response to the communication circuitry receiving the second radio frequency control signal and the second radio frequency control signal including the transmitter code.

19. The movable barrier operator system of claim 12 wherein the communication circuitry is configured to receive the first and second radio frequency control signals at different first and second frequencies; and
wherein the communication circuitry is configured to transmit a radio frequency communication to the unknown in-vehicle transmitter at the second frequency as part of learning the unknown in-vehicle transmitter.
